(19) United States
(12) Patent Application Publication
(10) Pub. No.: US 2010/0083547 A1
(43) Pub. Date: Apr. 8, 2010

(54) Method for Beautifying and Extending the Life of Sign Posts

(76) Inventor: Phil Cowen, New York, NY (US)

Correspondence Address: PATENT DOCKET ADMINISTRATOR;LOWENSTEIN SANDLER PC, 65 LIVINGSTON AVENUE, ROSELAND, NJ, 07068, US

(21) Appl. No.: 12/246,997

(22) Filed: Oct. 7, 2008

(51) Int. Cl. G09F 15/00; B32B 37/06

(52) U.S. Cl. 40/607.01; 156/86

(57) ABSTRACT

The present invention provides weather and use-protected sign posts, and methods of beautifying and extending the useful life of sign posts by protecting them against weather and use, through the application of a heat shrinkable material onto the post.

Sign posts are expected to be long-lasting and virtually maintenance-free. Once they are placed in the desired outdoor location, the owner ought to be able to walk away with peace of mind that the posts will remain intact and functional, as continually checking on the condition of sign posts can become burdensome. However, because of their constant exposure to elements, such as snow, wind, rain, and micro-organisms, ensuring that sign posts retain the integrity of their original characteristics can be a difficult task. Steel posts may develop rust. Not only is rust corrosive and unsightly, but also dangerous, as its rough surface serves as a prime habitat for C. tetani, the micro-organism that causes tetanus. Wooden posts may degrade over time due to wood decay fungi and other similar microorganisms that cause wood decay, and chemical treatments aimed at preventing such decay are often not environmentally friendly.

In addition to retaining structural integrity, sign posts must also be capable of retaining visual integrity. Sign posts are often visible to passersby and it is desirable that such posts remain visually pleasing. Sign posts may also need to be color-coded in order to communicate a certain message. For example, sign posts designating outdoor hiking trails must be uniquely colored so that hikers can distinguish one trail from another. But because sign posts are outside, they are vulnerable to color degradation from the sun's ultraviolet rays and thus may not maintain the colors they need in order to remain attractive and functional.

Currently, the only option for resolving these problems has been to utilize powder coatings or paints. However powder coatings and paints are not very durable, are burdensome to apply, may contain hazardous materials, may not be fade resistant, and posts can be costly to ship to and from the powder coater and/or painter. Thus, there remains a need to provide durable protection of the structural integrity of sign posts while simultaneously maintaining colors of such posts. The sign posts and methods of the present invention address these issues by reducing the need for constant repair, maintenance, and replacement of sign posts.

### OBJECTS AND SUMMARY OF THE INVENTION

It is an object of the present invention to provide a method of repairing and/or beautifying and extending the life of sign posts comprising (a) contacting at least a portion of sign post with a heat shrinkable material and (b) applying an effective amount of heat to the heat shrinkable material to shrink the heat shrinkable material onto the post, while maintaining the integrity of the post.

It is an object of the present invention to provide sign posts that have been repaired or protected using the methods described herein.

In preferred embodiments, the method of the present invention further comprises applying a suitable adhesive onto either the sign post in contact with the heat shrinkable material, or the heat shrinkable material prior to contacting the sign post with the heat shrinkable material.

In certain embodiments of the present invention, the excess heat shrinkable material remaining after the heat shrinkable material has shrunken onto the sign post is trimmed away.

In certain embodiments of the present invention, the heat shrinkable material is a flat sheet, tape or tubing. In most preferred embodiments, the heat shrinkable material is tubing.

In preferred embodiments, the heat shrinkable material is from about 0.030 inches to about 0.100 inches thick after recovery and more preferably from about 0.030 to about 0.050 inches thick.

In certain embodiments of the present invention, the heat shrinkable material is a material selected from the group consisting of a reaction product of dicarboxylic acids and diols, a polyolefin material, a copolymer or terpolymer with at least one monomer type of an alpha-olefin, a phenol/formaldehyde material, a phenoxy material, and polyurethane, a styrene butadiene rubber, a modified ethylene copolymer blend, a polyester, an epoxy polyester, and mixtures or variations thereof. In preferred embodiments, the heat shrinkable material comprises polyvinyl chloride.

In certain embodiments of the present invention, the heat shrinkable material comprises at least one additive selected from the group consisting of a colorant, a tackifier, a filler, a plasticizer, a processing oil, an antimicrobial agent, a UV curing agent, a magnetic/magnetisable material and mixtures thereof.

In preferred embodiments, the heat shrinkable material shrinks onto the sign post when the material reaches a temperature from about 85° C. to about 200° C. In more preferred embodiments, the heat shrinkable material shrinks at about 100° C.

In certain embodiments of the present invention, the sign post comprises wood, steel, or aluminum.

In certain embodiments of the present invention, the sign post is square, U-channel shaped, or round.

For purposes of the present invention, the terms “sign post” and “post” are used interchangeably and include, but are not limited to, sign posts made of wood, steel, aluminum, and other materials known in the art of which sign posts are typically constructed.

For the purposes of the present invention, the term “recovered” or “recovery” refers to the stage of the heat shrinkable material after it has undergone shrinkage by a heat source.

For the purposes of the present invention, the phrase “fully recovered” refers to heat shrinkable material that has undergone maximum shrinkage.

For the purposes of the present invention, the phrase “partially recovered” refers to heat shrinkable material that has not undergone maximum shrinkage.

For purposes of the present invention, the phrase “protective covering” refers to the heat shrinkable material after it has shrunken onto the sign post.

### DETAILED DESCRIPTION

As disclosed above, the present invention provides for a method of repairing or beautifying and extending the useful life of sign posts. The sign post of the present invention is covered with a heat shrinkable material which protects the covered portions of the post, thus minimizing the maintenance issues commonly associated with such posts after exposure to the elements, e.g. rusting, rotting, faded colors, dirt, scratches, and nicks.

The present invention may be employed to protect any type of sign post which requires protection from the elements and/or requires special coloring, such as sign posts, fencing stakes, and U-channel posts. Such sign post may be made of any suitable material, such as steel, wood, and aluminum.

The method of the present invention comprises contacting suitable sign posts with a heat shrinkable material and applying heat to the heat shrinkable material to shrink the heat shrinkable material onto the post. The heat is applied at an appropriate temperature to allow for the heat shrinkable material to adhere to the post, while still maintaining the structural and visual integrity of the post.

The method of the present invention provides a rugged, tight-fitting, hazard resistant protective covering which, in certain embodiments, also provides protection against ultraviolet light. In addition to these advantages, the heat shrinkable material is also easy to apply and can be used by virtually anyone with minimal instruction, and can be applied to a variety of materials, including for example steel, wood, and aluminum.

A further advantage of the present invention is that, in certain embodiments, the shrunken heat shrinkable material may be removed from the sign post. For example, a shallow incision may be made into the shrunken heat shrinkable material which was previously shrunken on the post, and the shrunken material may then be peeled off of the post. This allows for easy replacement of the shrunken heat shrinkable material, if, for example, the user wishes to alter the color of the post.

The heat shrinkable material used in the present invention may be made of any material known in the art which exhibits the properties of a protective coating and is shrinkable by heat, e.g., a reaction product of dicarboxylic acids and diols, a polyolefin material, a copolymer or terpolymer with at least one monomer type of an alpha-olefin, a phenol/formaldehyde material, a phenoxy material, and polyurethane, a styrene butadiene rubber, a modified ethylene copolymer blend, a polyester, an epoxy polyester, or mixtures or variations thereof. In preferred embodiments, the heat shrinkable material comprises polyvinyl chloride (PVC).

The heat shrinkable material will recover, or shrink down, to a smaller size when appropriate heat is applied. The thickness of the recovered heat shrinkable material depends upon the degree of recovery. For example, heat shrinkable material which is fully recovered will have a greater thickness than heat shrinkable material which is only partially recovered. Heat shrinkable material that has fully recovered can be half of the size or less of the material prior to sufficient heat exposure. With this in mind, the heat shrinkable material shrunken onto the post is preferably of an appropriate thickness to protect the post from the undesirable effects of daily exposure to the elements and environmental conditions. Thus, in preferred embodiments, the heat shrinkable material is from about 0.030 inches to about 0.100 inches thick after recovery and more preferably from about 0.030 to about 0.050 inches thick.

An adhesive agent may optionally be applied to either the portion of the post to be covered with the heat shrinkable material, or to the heat shrinkable material itself prior to the application of the heat shrinkable material onto the sign post. Any suitable multipurpose adhesive agent may be used, and one of skill in the art would recognize which multipurpose adhesives would be applicable for the methods describes herein.

The shrinking of the heat shrinkable material onto the post not only provides protection for the sign post, but also provides a smooth, aesthetically pleasing surface. To add to the cosmetic appearance of the protective covering, the heat shrinkable material used in the present invention may be clear or any particular color, depending on the user's preference. In certain embodiments, the heat shrinkable material used in the present invention may also be paintable. Additionally, the heat shrinkable material used may be high gloss, matte, metallic, neon or pearlescent, depending on the user's needs.

Many polymers may be degraded by (UV) light and pigments and dyes can absorb UV and change color. Therefore, in certain embodiments, the heat shrinkable material used in the present invention provides protection against ultraviolet (UV) light, which helps to maintain the durability and color of the post.

The heat source used to shrink the heat shrinkable material may be any heat source known in the art capable of emitting sufficient heat to cause the heat shrinkable material to shrink onto the post. Preferably, the temperature emitted from the heat source is from about 100° C. to about 2000° C. A preferred heat source for use in the present invention is a heat gun.

### EXAMPLE

### Example 1

### Covering a Sign Post

Heat shrinkable tubing, that is 20-40% larger in diameter than the sign post to be covered, would be cut 8.0 in. longer than the length of the post. The sign post would be sprayed with a multipurpose adhesive**, then held vertically and the heat shrinkable tubing would be slid onto the post.

Starting at the top of the sign post, heat would be applied to the tubing with a heat gun. The heat shrinkable material would be pressed downwards towards the bottom of the sign post to form a snug fit. The sign post would be rotated throughout the process to ensure even melting of the heat shrinkable material.

The excess tubing would be trimmed away from the post, and heat reapplied to provide a smooth surface.
** The multi-purpose adhesive spray is an optional step and not required for the heat shrinkable material to adhere onto the sign post.

What is claimed:

1. A method of beautifying and extending the useful life of sign posts comprising:
(a) contacting at least a portion of an sign post with a heat shrinkable material;
(b) applying an effective amount of heat to said heat shrinkable material to shrink the heat shrinkable material onto the sign post while maintaining the integrity of the sign post.

2. The method of claim 1, further comprising trimming away excess heat shrinkable material after the heat shrinkable material has shrunken onto the sign post.

3. The method of claim 1, wherein the heat shrinkable material is a flat sheet, tape or tubing.

4. The method of claim 1, wherein the heat shrinkable material comprises a material selected from the group consisting of a reaction product of dicarboxylic acids and diols, a polyolefin material, a copolymer or terpolymer with at least one monomer type of an alpha-olefin, a phenol/formaldehyde material, a phenoxy material, and polyurethane, a styrene butadiene rubber, a modified ethylene copolymer blend, a polyester, an epoxy polyester, and mixtures thereof.

5. The method of claim 1, wherein the heat shrinkable material comprises polyvinyl chloride.

6. The method of claim 1, wherein said heat shrinkable material comprises at least one additive selected from the group consisting of a colorant, a tackifier, a filler, a plasticizer, a processing oil, an antimicrobial agent, a UV curing agents, a magnetic/magnetisable material and mixtures thereof.

7. The method of claim 1, wherein said heat shrinkable material shrinks at a temperature of about 85° C. to about 200° C.

8. The method of claim 1, wherein said heat shrinkable material provides UV protection.

9. The method of claim 1, wherein the heat shrinkable material has a thickness of from about 0.030 to about 0.50 after recovery.

10. A sign post comprising a heat shrinkable material surrounding at least a portion of the sign post, wherein said heat shrinkable material has been exposed to an effective amount of heat to shrink the heat shrinkable material onto the sign post.

11. The sign post of claim 10, wherein said heat shrinkable material provides protection from damage of the sign post.

12. The sign post of claim 10, wherein the heat shrinkable material is in the shape of a flat sheet, tape or tubing prior to application to the sign post.

13. The sign post of claim 10, wherein the heat shrinkable material is a material selected from the group consisting of a reaction product of dicarboxylic acids and diols, a polyolefin material, a copolymer or terpolymer with at least one monomer type of an alpha-olefin, a phenol/formaldehyde material, a phenoxy material, and polyurethane, a styrene butadiene rubber, a modified ethylene copolymer blend, a polyester, an epoxy polyester, and mixtures thereof.

14. The sign post of claim 10, wherein the heat shrinkable material comprises polyvinyl chloride.

15. The sign post of claim 10, wherein said heat shrinkable material comprises at least one additive selected from the group a colorant, a tackifier, a filler, a plasticizer, a processing oil, an antimicrobial agent, a UV curing agents, a magnetic/magnetisable material and mixtures thereof.

16. The sign post of claim 10, wherein said heat shrinkable material shrinks at a temperature of from about 85° C. to about 200° C.

17. The sign post of claim 10, wherein said heat shrinkable material provides protection against UV light.

18. A method of beautifying and extending the useful life of a sign post comprising:
(a) inserting at least a portion of a sign post into a tubing comprising a PVC-based heat shrinkable material which provides protection against UV light; and
(b) exposing the heat shrinkable material to a heat source which causes the temperature of the heat shrinkable material to reach about 90° C. to about 110° C. to shrink the heat shrinkable material onto the sign post while maintaining the integrity of the sign post.
